(19) United States
(12) Patent Application Publication
(10) Pub. No.: US 2023/0112898 A1
(43) Pub. Date: Apr. 13, 2023

(54) METHOD FOR COMPENSATING FOR A MALFUNCTION OF A FIELD DEVICE IN AN AUTOMATION TECHNOLOGY PLANT

(71) Applicant: Endress+Hauser Process Solutions AG, Reinach (CH)

(72) Inventors: Marco Braun, Jena (DE); Alexander Franke, Birsfelden (CH); Dietmar Frühauf, Lörrach (DE)

(21) Appl. No.: 17/757,194

(22) PCT Filed: Nov. 20, 2020
(86) PCT No.: PCT/EP2020/082909

§ 371 Date: Jun. 10, 2022

(30) Foreign Application Priority Data
Dec. 11, 2019 (DE) 10 2019 134 023.3

(51) Int. Cl. G05B 19/418

(52) U.S. Cl. CPC G05B 19/4184; G05B 2219/39191

(57) ABSTRACT

A method for compensating for a malfunction of a field device, includes monitoring process values transmitted by each field device to a superordinated unit; creating historical data based on the transmitted process values for each field device or the sensor unit; establishing a replacement system based on the historical data, wherein the data processing unit ascertains which process variable of a sensor unit can serve as substitute variable to replace a process variable of a further sensor unit; comparing the current process values of the field device, or the sensor unit, with desired values for precalculating periods of time, in which current process values differ by at least one predetermined value from the desired values; and transmitting the substitute variable to the superordinated unit of the data processing unit during the precalculated periods of time.

The invention relates to a method for compensating for a malfunction of a field device in an automation technology plant, wherein a plurality of field devices are provided in the plant, wherein each of the field devices has at least one sensor unit, which is embodied for registering at least one process variable, wherein the field devices are incorporated into a communication network and communicate with a superordinated unit, as well as with one another, and wherein the field devices transmit obtained process values, diagnostic data and status information via the communication network to the superordinated unit.

Known from the state of the art are field devices, which are used in industrial automation technology plants. In process automation, as well as in manufacturing automation, field devices are often applied. Referred to as field devices are, in principle, all devices, which are applied near to a process and which deliver, or process, process relevant information. Field devices are used for registering and/or influencing process variables. Serving for registering process variables are sensor units. Such are used, for example, for pressure- and temperature measurement, conductivity measurement, flow measurement, pH measurement, fill level measurement, etc. and register the corresponding process variables, pressure, temperature, conductivity, pH value, fill level, flow, etc. Used for influencing process variables are actuator systems. Such are, for example, pumps or valves, which can influence the flow of a liquid in a tube or pipe or the fill level in a container. Besides the above mentioned measuring devices and actuators, referred to as field devices are also remote I/Os, radio adapters, and, in general, devices, which are arranged at the field level.

In modern industrial plants, field devices are, as a rule, connected with superordinated units via communication networks, such as, for example, fieldbusses (Profibus®, Foundation® Fieldbus, HART®, etc.). The superordinated units are control units, such as, for example, a PLC (programmable logic controller). The superordinated units serve, among other things, for process control, as well as for commissioning of field devices. The measured values registered by field devices, especially sensor units, are transmitted via the given bus system to one or more superordinated units, which, in given cases, process the measured values further and forward them to the control station of the plant. The control station serves for process visualizing, process monitoring and process control via the superordinated units. In addition, also a data transmission from the superordinated unit over the bus system to the field devices is required, especially for configuration and parametering of field devices as well as for operation of actuators.

The failure of a field device can mean high costs and time consumed. Especially in critical processes, the plant part in question must be shut down, until the field device has been repaired or replaced. As alternative thereto, often redundancies are earlier installed in the relevant plant part. In such case, these are, as a rule, field devices equal to the installed field devices, so that they can fill-in in the case of failure of an affected field device. The point in time of a malfunction is frequently not predictable, such that a failure can sometimes occur suddenly.

Based on the above, an object of the invention is to provide a method, which facilitates maintenance of an automation technology plant.

The object is achieved by a method for compensating for a malfunction of a field device in an automated process plant, wherein a plurality of field devices are provided in the plant (P), wherein each of the field devices has at least one sensor unit, which is embodied for registering at least one process variable, wherein the field devices are grouped in at least one measuring location, wherein the field devices are incorporated into a communication network and communicate with a superordinated unit, wherein the field devices transmit obtained process values, diagnostic data and status information via the communication network to the superordinated unit, wherein the superordinated unit transmits obtained process values, diagnostic data and status information to a control station of the plant and wherein each measuring location includes a data processing unit, which is arranged in the communication network between the field devices of the corresponding measuring location and the superordinated unit, comprising:
monitoring by the data processing unit of the process values transmitted by the field devices to the superordinated unit;
creating by means of the data processing unit historical data based on the transmitted process values for each of the field devices;
establishing a replacement system based on the historical data, wherein the data processing unit ascertains, in the course of establishing the replacement system, which process variable of a sensor unit can serve with predetermined accuracy as substitute variable to replace a process variable of a further sensor unit;
comparing current process values of each of the field devices with desired values formed from the historical data and/or by earlier set reference values for precalculating periods of time, in which current process values of a field device differ by at least one predetermined value from the desired values;
transmitting the substitute variable for the field device to the superordinated unit by means of the data processing unit during the precalculated periods of time.

A significant advantage of the method of the invention is that failure of a field device, or its sensor units, can be temporally foreseen and cared for in simple manner. Instead of providing a redundant replacement device, the data processing unit independently predictively ascertains those time periods, in which a field device, or its sensor unit, will fail and supplementally determines a substitute variable for the lost process variable. This holds for the measuring location, such that, thus, a field device of the measuring location can replace another field device of the measuring location. Also, it can be provided that the data processing units communicate via the communication network, such that also field devices of different measuring locations can provide substitute variables for one another. The substitute variable is transmitted to the superordinated unit by the data unit beginning with the ascertained time period, until the time period is ended or until a user terminates the transmission. The failed field device, or its sensor unit, can in the intervening time be repaired or replaced, without requiring that the affected plant part must be shut down and the process interrupted, whereby the availability of the process is increased.

The substitute variable can also be formed from a combination of a plurality of process variables from one or more sensor units. For example, instead of a failed, radar based, fill level measurement device, the process variables of a plurality of limit switch or pressure measuring devices can be combined, in order to obtain a substitute variable for the fill level in a tank.

The desired accuracy of the substitute variable compared with the lost process variable can be established earlier by the user. In this way, field devices, or sensor systems, whose registered process variables differ too much from those of the failed field device, are not taken into consideration.

In this way, for example, a temperature sensor can replace a failed temperature sensor. The data processing unit knows the type of registered process values of all field devices, or their sensor units, and their typical sizes.

Examples of field devices and their sensor units, which can be used in connection with the method of the invention, have already been described by way of example in the introductory part of the description.

The data processing units are electronic devices, which are connectable with the communication network and which have electronics containing, for example, a microprocessor and a memory unit, suitable for processing data obtained from the communication network. For example, the data processing unit is an industrial PC or a gateway/a switch.

It is provided that a wired communication network, especially an Ethernet based, communication network, is used as communication network. It can, in such case, also be an automation fieldbus, for example, based on one of the protocols, HART, Profibus PA/DP, Foundation Fieldbus, etc. It can also be provided that the communication network is composed of a plurality of segments, which, in given cases, operate based on different protocols.

Alternatively, it can be provided that a wireless communication network is used as communication network. Especially, this can be based on the WLAN-, or WiFi standard. Alternatively, any other conventional wireless standard can be used.

In an advantageous embodiment of the method of the invention, it is provided that the device status of the field devices and/or sensor units is transmitted to the superordinated unit, especially continually or at certain points in time, and wherein upon occurrence of at least one predetermined device status of a field device, or sensor unit, the substitute variable is transmitted to the superordinated unit by means of the data processing unit.

Examples of device status, which trigger transmission of the substitute variable, are, for example, “maintenance required” and/or “device offline”. A failure of a field device, or a sensor unit, can, thus, also be compensated for, when the failure suddenly occurs, and, especially, could not be foreseen per reconciliation of its process values with the desired values.

In a preferred additional development of the method of the invention, it is provided that, in the course of establishing the replacement system, other properties of a field device, or a sensor unit, are transmitted to the data processing unit and compared. The accuracy of the substitute variable is increased in this way, since not only the pure process measured values of the actual process variable are compared with potential process variables, but, instead, other, meta data are incorporated. These additional data are incorporated into the calculating of the accuracy of a potential substitute variable.

In an advantageous embodiment of the method of the invention, it is provided that the additional properties include information relative to geographical position of the field device.

In a preferred embodiment of the method of the invention, it is provided that the additional properties include information relative to the measuring location, where the field device is installed, and/or information relative to the function of the field device at the measuring location.

In an advantageous embodiment of the method of the invention, it is provided that the additional properties of the field devices are transmitted to the data processing unit and/or wherein the additional properties are transmitted from a service platform to the data processing unit. By way of example, this information, for instance, information relative to the positioning of the field devices, can be obtained by the field devices themselves. An operator can also input the additional information to the service platform or its own databases can be placed on the service platform. The service platform is an application in a cloud server and is accessible by a user over the Internet, or exchanges data with the data processing unit via the Internet.

In a preferred embodiment of the method of the invention, it is provided that, in the course of establishing the replacement system, historical data, position information and/or information relative to a measuring location of field devices located in plants other than the plant are taken into consideration. In this way, knowledge of other measuring locations can be accessed and the quality of the substitute variable further increased. This additional information is located likewise on the service platform or on additional platforms, which have interfaces for data exchange with the service platform.

In an advantageous embodiment of the method of the invention, it is provided that the data processing unit uses an AI algorithm, especially one based on neural networks, for establishing the replacement system and/or for precalculating the time periods. Besides neural networks, other suitable AI algorithms, for example, based on Deep Learning, can be used.

In an advantageous embodiment of the method of the invention, it is provided that the AI algorithm is trained earlier on a service platform and wherein the so trained algorithm is loaded earlier into the data processing unit. It can, in such case, be the above described service platform, or another service platform. The algorithm is trained on a plurality of applications of field devices and learns, thus, a series of error constellations of the field devices, or sensor units, possible relationships between error constellations and failures, e.g. their temporal behavior and links between process variables of various sensor units with one another in different applications. After the training, the so trained algorithm is integrated into the data processing unit.

In an advantageous embodiment of the method of the invention, it is provided that the steps of establishing the replacement system and/or precalculating the time periods are executed, without there being a communication connection between the data processing unit and the service platform. It can be provided to update this algorithm in regular or irregular length of times, in order to be able to implement newly learned findings and to improve the precalculating and/or the replacement system. For this, a communication connection between the data processing unit and the service platform is, however, required.

In a preferred additional development of the method of the invention, it is provided that the data processing unit compares the history of the substitute variable with the historical data of the field device, or the sensor unit, which has the predetermined device status, and ascertains a deviation of the substitute variable from the historical data. A deviation results, for example, in that the sensor unit, which registers the potential substitute variable, has a measuring principle other than that of the sensor unit, which registers the process variable to be replaced. Also, another site of installation or other calibrating of the sensor unit, which registered the potential substitute variable, can lead to a deviation. The deviation can be constant or non-constant, in which case, for example, it can increase or decrease over the course of time.

In an advantageous embodiment of the method of the invention, it is provided that the data processing unit corrects the substitute variable by the ascertained deviation in real time. In the case of a constant deviation, the substitute variable is increased or decreased by this constant deviation, depending on its sign. In the case, in which a non-constant deviation is present, the deviation to be corrected is earlier calculated and adapted continually.

In a preferred additional development of the method of the invention, it is provided that the data processing unit, e.g. gateway, calculates an evaluation of the ascertained substitute variable.

In an advantageous embodiment of the method of the invention, it is provided that the evaluation of the substitute variable is made known to an operator before transmission of the substitute variable and the substitute variable is transmitted only when the operator confirms this. The evaluation of the substitute variable is calculated from the accuracy of the substitute variable and the deviation of the substitute variable. The less constant the deviation of the substitute variable is, and accordingly difficult a reliable prediction of the substitute variable is, the more negative is the evaluation of the substitute variable.

In a preferred embodiment of the method of the invention, it is provided that the amount of the historical data of the field device, or the sensor unit, which has the predetermined device status, is taken into consideration for calculating the evaluation. The more historical data of a field device, or sensor unit, that are present, the more information is present concerning the behavior of such field device, or sensor unit, during operation at the measuring location. This in turn increases the information provided by the calculating.

The invention will now be explained in greater detail based on the appended drawing, the sole FIGURE of which shows as follows:

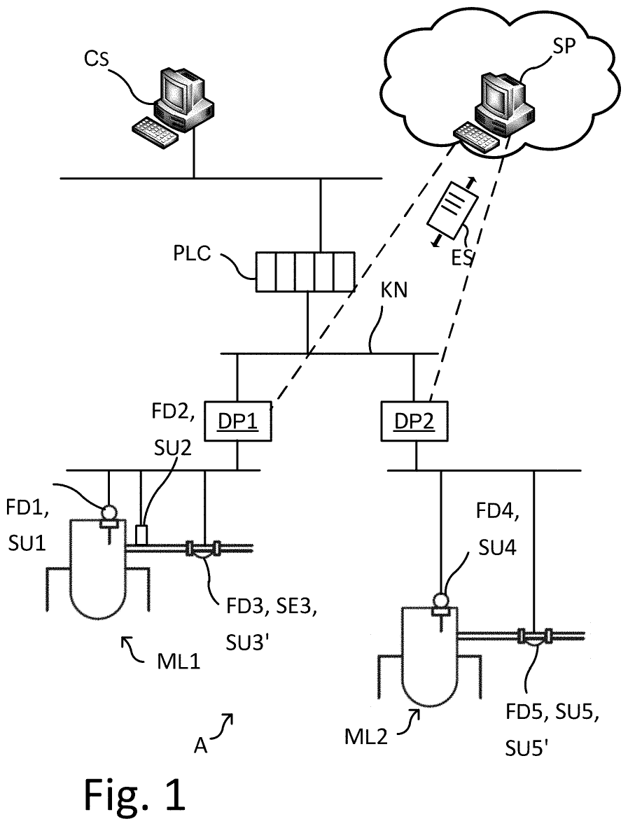

FIG. 1 a first example of an embodiment of the method of the invention.

Shown in FIG. 1 are parts of an automation technology plant P. In particular, there are two measuring locations ML1, ML2. Such are composed, in each case, of a tank and a pipeline leading away from the tank. Provided on the tanks for measuring their fill levels as process variables are the field devices FD1 and FD4, respectively, for example, fill level measurement devices formed by means of radar-based sensor units SU1 and SU4, respectively. Provided for measuring flow velocity in the pipelines are field devices FD3 and FD5, respectively, whose sensor units SU3 and SU5, respectively, use the Coriolis principle to determine flow velocity of media flowing through the pipelines as primary process variables. Each of the field devices FD3, FD5 includes, furthermore, a temperature sensor SU3′, SU5′, respectively, as further sensor units, which register temperature of the media flowing through the pipelines as secondary process variables. Furthermore, measuring location ML1 has an additional field device FD2, which determines the temperature of the measured medium flowing through the pipeline by means of a high accuracy temperature sensor as sensor unit SU2.

The field devices FD1, . . . , FD5 are connected with one another by means of a communication network KN and can communicate with one another. Communication network KN is especially an Ethernet network. Alternatively, the communication network KN can be formed by means of a fieldbus according to one of the known fieldbus standards, for example, Profibus, Foundation Fieldbus or HART.

Communication network KN includes a superordinated unit PLC, for example, a programmable logic controller, which transmits commands to the field devices FD1, . . . , FD5, whereupon the field devices FD1, . . . , FD5 transmit process values, diagnostic data and status information to the superordinated unit PLC. These process values, diagnostic data and status information are forwarded from the superordinated unit PLC to a work station PC in the control station CS of the plant P for, among other things, process visualizing, process monitoring and engineering as well as for servicing and monitoring the field devices FD1, . . . , FD5.

Furthermore, each of the measuring locations ML1, ML2 includes a data processing unit DP1, DP2, especially a gateway or an industrial PC, which registers the process values, diagnostic data and status information transmitted from the field devices FD1, . . . , FD5 contained in the measuring locations ML1, ML2 to the superordinated unit PLC.

Via the Internet, the data processing units DP1, DP2 can establish communication connections to a service platform SP. The service platform SP is embodied to execute applications. An example of such applications is a plant asset management system, which serves for managing the assets, thus, the inventory, of the plant P.

The following describes an example of how the method of the invention works:

In order to be ready to react to a failure of a field device FD1, . . . , FD5, or a sensor unit SU1, . . . , the data processing unit DP1, DP2 obtains information of the field devices FD1, . . . , FD5. Thus, the data processing unit DP1, DP2 monitors the data traffic transmitted via the communication network KN or sends direct queries to the field devices FD1, . . . , FD5. Information obtained from the field devices FD1, . . . , FD5 is information relative to the type of process variables registrable by their sensor units SU1, . . . , SU5′, information concerning geographical positioning of the field devices FD1, . . . , FD5, information concerning the measuring locations ML1, ML2, where the field devices FD1, . . . , FD5 are installed, information concerning function of the field devices FD1, . . . , FD5 at the measuring locations ML1, ML2, information concerning process variables registered by the sensor units SU1, . . . , SU5′ and information with reference to historical data of the process variables registered by the sensor units SU1, . . . , SU5′. Furthermore, the device status of the field devices FD1, . . . , FD5 and/or device status of their sensor units SU1, . . . , SU5′ is obtained. It can also be provided that at least one part of this information and/or other information already on the service platform SP is stored, or that such information is, for example, loaded from databases of the plant operator.

In the data processing units DP1, DP2, an AI algorithm is implemented, which continually analyzes the monitored data, examines historical data and detects trends, for example, a continuously rising deviation of the process values of a sensor unit SU1, . . . , SU5′ from the historical values. The AI algorithm is trained. The training is executed earlier on the service platform SP using process values, state data, etc.

In order to be able to react to a failure of a field device FD1, . . . , FD5, or a sensor unit SU1, . . . , SU5′, without requiring that the process of the plant P, or the measuring locations ML1, ML2, be interrupted, the data processing units create a replacement system RS. This includes all sensor units SU1, . . . , SU5′ of the field devices FD1, . . . , FD5, their registered process variables and for each of the sensor units SU1, . . . , SU5′, in each case, a list of those sensor units SU1, . . . , SU5′, which can replace one of the sensor units SU, . . . , SU5′ as substitute variable in the case of a failure. In such case, it can be provided that a data processing unit DP1, DP2, for creating the replacement system, relies only on the field devices FD1, . . . , FD5 of its measuring location ML1, ML2 and field devices of other measuring locations are not taken into consideration. Alternatively, such as in the present case, the data processing units DP1, DP2 communicate with one another and create a global replacement system RS. Furthermore, for each of the substitute variables, an accuracy is calculated, showing the extent to which a substitute variable agrees with the process variable to be replaced. The creation of the replacement system RS is likewise based by means of the AI algorithm on the monitored data traffic. Also in such case, the AI algorithm is trained earlier on the service platform SP. In such case, the treasure trove of experience of already existing replacement systems, which were created for other plants, can be accessed and this experience taken into consideration in the creating of the replacement system RS. For this, the data processing unit DP1, DP2 transmits the created replacement system RS including information concerning field devices FD1, . . . , FD5 and their sensor units SU, . . . , SU5′ to the service platform SP.

In the example shown in FIG. 1, in a first variant, the temperature sensor SU2 of the field device FD2 shows a drift. The data processing unit DP1 registers this drift and calculates from the drift that the temperature sensor will fail after a certain length of time, for example, 3 days. Other methods for predicting an oncoming failure are described at length in the state of the art.

In a second variant, the temperature sensor SU2 of the field device FD2 fails some time after creating the replacement system RS. The field device transfers into the device status, “maintenance required”, and no longer issues new temperature values. The new device status is registered by the data processing unit DP1.

In both cases, the replacement system RS then gets busy, determines substitute variables for the failed process variable and compares the accuracy of each of the potential substitute variables with one another.

In the present example, two potential substitute variables are determined: The temperature of the temperature sensor SU3′ of the field device FD3, and the temperature of the temperature sensor SU5′ of the field device FD5. Then, the accuracies of the two potential substitute variables are compared with one another. The potential substitute variable of the field device FD5 delivers in such case a low, insufficient accuracy. Field device FD5 is located in a measuring location ML2 different from the measuring location ML1, such that also the historical data of the field devices FD2 and FD5 can differ greatly from one another.

The potential substitute variable of the field device FD3 shows a high accuracy. The field device FD3 is located in the same measuring location ML1, where the field device FD2 is located. Except for a slight offset, the historical data of the field devices FD2 and FD3 are equal, such that the substitute variable reflects sufficiently well the temperature of the measured medium in the pipeline.

The size of the offset is determined based on comparison of the historical data of the process variable to be replaced with the historical data of the substitute variable and is stored as deviation.

Then, an evaluation of the substitute variable can be calculated. Such is calculated from the ascertained quality of the substitute variable and the historical data of the substitute variable. In such case, a high evaluation results, since in addition to the high quality of the substitute variable the historical data show few fluctuations.

Then, the substitute variable and the value of the deviation are reported to the superordinated unit PLC. This continually corrects the values of the substitute variable and forwards current values of the substitute variable continually to the control station CS of the plant with the remark, “substitute variable for SU2”, where it can be used and evaluated until the maintenance of the field device FD2. Alternatively, the superordinated unit PLC forwards the value of the deviation to the control station CS and does not correct the current values of the substitute variable.

A significant advantage of the method of the invention is that the process does not need to be shut down and can be continued without problem. Depending on criticality of the process, the required accuracy of the substitute variable must, however, be set correspondingly high, in order to be able to assure continued operation of the process without danger.

The substitute variable can also be formed from a combination of a number of process variables from one or more of the sensor units SU1, . . . , SU5′. For example, in place of a failed, radar based, fill level measurement device FD1, FD4, the process variables of a number of limit switches or pressure measuring devices (not shown) can be combined, in order to obtain a substitute variable for the fill level in a tank of one of the measuring locations ML1, ML2.

### LIST OF REFERENCE CHARACTERS

P plant automation technology
DP1, DP2 data processing unit
RS replacement system
FD1, FD2, FD3, FD4, FD5 field device
KN communication network
CS control station of the plant
ML1, ML2 measuring location
SU1, SU2, SU3, SU3′, SU4, SU5, SU5′ sensor unit
SP service platform
PLC superordinated unit, control unit

1-15. (canceled)

16. A method for compensating for a malfunction of a field device in an automated process plant, wherein a plurality of field devices are provided in the plant, wherein each of the field devices has at least one sensor unit, which is embodied for registering at least one process variable, wherein the field devices are grouped in at least one measuring location, wherein the field devices are incorporated into a communication network and communicate with a superordinated unit, wherein the field devices transmit obtained process values, diagnostic data and status information via the communication network to the superordinated unit, wherein the superordinated unit transmits obtained process values, diagnostic data and status information to a control station of the plant and wherein each measuring location includes a data processing unit, which is arranged in the communication network between the field devices of the corresponding measuring location and the superordinated unit, comprising:
monitoring by the data processing unit of the process values transmitted by the field devices to the superordinated unit;
creating using the data processing unit historical data based on the transmitted process values for each of the field devices, or the sensor units;
establishing a replacement system based on the historical data, wherein the data processing unit ascertains, in the course of establishing the replacement system, which process variable of a sensor unit can serve with predetermined accuracy as substitute variable to replace a process variable of a further sensor unit;
comparing current process values of each of the field devices, or the sensor units, with desired values formed from the historical data and/or by earlier set reference values for precalculating periods of time, in which current process values of a field device, or the sensor units, differ by at least one predetermined value from the desired values; and
transmitting the substitute variable for the field device, or the sensor units, to the superordinated unit using the data processing unit during the precalculated periods of time.

17. The method as claimed in claim 16, wherein the device status of the field devices and/or sensor units is transmitted to the superordinated unit, especially continually or at certain points in time, and wherein upon occurrence of at least one predetermined device status of a field device, or a sensor unit, the substitute variable is transmitted to the superordinated unit by means of the data processing unit.

18. The method as claimed in claim 16, wherein, in the course of establishing the replacement system, other properties of a field device, or a sensor unit, are transmitted to the data processing unit and compared.

19. The method as claimed in claim 18, wherein the additional properties include information relative to geographical position of the field device.

20. The method as claimed in claim 18, wherein the additional properties include information relative to the measuring location, where the field device is installed, and/or information relative to the function of field device at the measuring location.

21. The method as claimed in claim 18, wherein the additional properties of the field devices are transmitted to the data processing unit and/or wherein the additional properties are transmitted from a service platform to the data processing unit.

22. The method as claimed in claim 18, in the course of establishing the replacement system, historical data, position information and/or information relative to a measuring location of field device located in plants other than the plant are taken into consideration.

23. The method as claimed in claim 16, wherein the data processing unit uses an AI algorithm, especially based on neural networks, for establishing the replacement system and/or for precalculating the time periods.

24. The method as claimed in claim 23, wherein the AI algorithm is trained earlier on a service platform and wherein the so trained algorithm is loaded earlier into the data processing unit.

25. The method as claimed in claim 24, wherein the steps of establishing the replacement system and/or precalculating the time periods are executed, without there being a communication connection between the data processing unit and the service platform

26. The method as claimed in claim 16, wherein the data processing unit compares the history of the substitute variable with the historical data of the field device, or the sensor unit, which has the predetermined device status, and ascertains a deviation of the substitute variable from the historical data.

27. The method as claimed in claim 26, wherein the data processing unit corrects the substitute variable by the ascertained deviation in real time.

28. The method as claimed in claim 16, wherein the data processing unit calculates an evaluation of the ascertained substitute variable.

29. The method as claimed in claim 28, wherein the evaluation of the substitute variable is made known to an operator before the transmission of the substitute variable and wherein the substitute variable is transmitted only when the operator confirms this.

30. The method as claimed in claim 28, wherein the amount of the historical data of the field device, or the sensor unit, which has the predetermined device status, is taken into consideration for calculating the evaluation.
